(19) United States
(12) Patent Application Publication
(10) Pub. No.: US 2018/0046797 A1
(43) Pub. Date: Feb. 15, 2018

(54) METHOD FOR INPUTTING A SECURE PASSWORD, SHEET, SET OF SHEETS, INPUT UNIT, AND USES THEREOF

(71) Applicant: David MAUPOUX, Saint-Germain-en-Laye (FR)

(72) Inventor: David MAUPOUX, Saint-Germain-en-Laye (FR)

(21) Appl. No.: 15/789,977

(22) Filed: Oct. 21, 2017

Related U.S. Application Data
(63) Continuation-in-part of application No. 14/778,833, filed on Oct. 29, 2015, now abandoned.

(30) Foreign Application Priority Data
Mar. 22, 2013 (FR) 1352593

(51) Int. Cl. G06F 21/46; G06F 21/34; G06F 21/83; G06F 21/31; G06F 21/60

(52) U.S. Cl. CPC G06F 21/46; G06F 21/31; G06F 21/604; G06F 21/83; G06F 21/34

(57) ABSTRACT

The sheet for the implementation of the method bears a plurality of patterns positioned in pattern positions, each pattern position corresponding to a symbol position on a predetermined physical interface.

The sheet is flexible so that the pressing of a finger of a user on a pattern causes the input of a symbol, through the flexible sheet, on the physical symbol input interface, each pattern of a plurality of patterns on the flexible sheet representing a letter.

### FIELD OF THE INVENTION

The present invention concerns a method for inputting a secure password, a sheet, set of sheets and a unit of input elements for its utilization, and the uses thereof.

The present invention thus relates more specifically to the field of computer security.

### STATE OF THE ART

Methods and systems are known, in the state of the art, that have been developed to strengthen computer security. In particular, the combination of a login and a password is used to access personal data, such as the customer account, on the majority of websites.

However, these passwords are subject to conflicting requirements:
firstly, the users must not note them down in a way that is accessible to malicious third parties, for example in computer files on their user terminal;
the users must therefore memorize them, which implies passwords that are intuitive, related to the real world, and short;
the malicious third parties searching for passwords therefore test for passwords formed from common or proper words that are easy to memorize; and
as the power of the computer systems available to malicious third parties is growing significantly, the length of the passwords must also be increased regularly.

In addition, the passwords should be changed regularly to strengthen security. But the memorization requirements described above make most of the sites and users forgo this level of security, except for passwords formed solely from digits, for example on bank sites. Because of the very fact that these are limited in number (10 digits compared to 26 letters or 36 letters and digits, not counting the other linguistic characters and the special characters and combinations of keyboard keys), their level of security is inherently limited.

In conclusion, the security of access to personal data is low and declining rapidly.

Document US 20120050005, which describes a physical non-human readable representation of a digital key on a physical key article (see abstract and claims), is known.

This system has a number of drawbacks.

In all the embodiments described, a software system is placed on the user terminal to validate the non-human readable representation of the digital key.

Because there must be a specific software system on the user terminal (see FIGS. 3 and 4), the level of security is low for all the embodiments described in this document.

This document's preamble states that the problems that may be overcome by what it describes are:
the discrimination, by the users, of the characters to be input, such as software serial numbers consisting of a string of characters (e.g. distinguishing “0” from “O”, “I” from “1”);
the use of serial numbers by the visually impaired;
data entry errors; and
spaces and hyphens, where the users are unsure whether they have to be input or not.

Therefore, this document in no way envisages the problem of transforming passwords that are long but easy to memorize into passwords that comprise no word that is easily tested for by a malicious third party.

### DESCRIPTION OF THE INVENTION

The present invention intends to remedy all or part of the inconveniences of the prior art described above.

To this end, according to a first aspect, the present invention envisages a method of generating and using passwords, characterized in that it comprises:

during a initialization phase:
a first step of supplying, by the user, in an identifier input field displayed on a screen of a terminal, an identifier of the user,
a first step of accessing a user password declaration field, by the user;
a first step of affixing, on a physical symbol input interface comprising a plurality of symbols positioned in symbol positions, a flexible sheet bearing a plurality of patterns positioned in pattern positions, each pattern position being superposed on a symbol position, the pressing of a finger of the user on a pattern causing the input of a symbol, through the flexible sheet, on the physical symbol input interface, each pattern of a plurality of patterns on the flexible sheet representing a letter;
a first step of input, by the user, by pressing on patterns of the flexible sheet, of a first arbitrary password comprising a plurality of patterns representative of letters, causing the reception by the physical interface, through the flexible sheet, of a sequence of symbols constituting a second password, each reception of a symbol by the physical interface causing the display, in the declaration field, of a sign confirming the reception and
a step of memorization, by a computer system, of the pair of information constituted of the sequence of symbols constituting the second password and of the user identifier as a pair of information authorizing the access to the resource and

during a utilization phase:
a second step of supplying, by the user, in the identifier input field displayed on a screen of a terminal, the identifier of the user,
a second step of accessing a user password declaration field, by the user;
a second step of affixing, on a physical symbol input interface, the flexible sheet each pattern position being superposed on a symbol position;
a second step of input, by the user, by pressing on patterns of the flexible sheet, of the first password causing the reception by the physical interface, through the flexible sheet, of the sequence of symbols constituting the second password, each reception of a symbol by the physical interface causing the display, in the declaration field, of a sign confirming the reception and
a step of verification of correspondence, in a memory, of the pair of information constituted of the sequence of symbols constituting the second password and of the user identifier;
if the second password corresponds to the user identifier, a step of accessing the resource.

In this way, transcribing the first password, which is understandable and therefore can be memorized by the user, into a second password, which is incomprehensible both to the user and to a third party who would like to discover it, strengthens the level of security without requiring any effort on the part of the user. Because no specific software system is required on the user terminal, no malware program such as a keylogger or Trojan horse and no remote control of this terminal can reveal the first password.

It is noted that, by regularly changing the flexible sheet, the present invention allows the second password to be regularly changed, as is recommended for computer security, while continuing to use the same first password. Similarly, with several flexible sheets it is possible to use different second passwords to access different resources, while using the same first password.

In this way, a user can have a password “for life”, which is used as a first password, for example formed from his last name, at least one first name and a date of birth, appended without spaces, e.g. “SylvieThorelJune251969”, which provides an easily remembered 22-character code, currently sufficient with regard to the computing power of the of the computer systems available to malicious third parties, even well-equipped secret services.

To further increase the security of the second password, actually used to access a resource, the distribution of patterns on the flexible sheet and each of the passwords are preferably unique for each user, and the patterns imprinted on each flexible sheet are preferably random.

In some embodiments, the method that is the subject of the present invention comprises a step of simultaneously providing:
the first password; and
said flexible sheet, each flexible sheet being different for each user so that inputting the same first password on two flexible sheets causes two different second passwords to be input.

For example, in these embodiments, a bank supplies, for accessing the account of each of its customers:
a letter or flexible card bearing the first password (for example “mybankcode”); and
a unique flexible sheet (different for each customer).

The bank's computer system memorizes the second password resulting from inputting the first password on the flexible sheet.

In some embodiments, said flexible sheet is made of a silicone elastomer, an elastomer of a different composition, plastic, fabric or paper.

In some embodiments, said patterns are imprinted on said flexible sheet by screen printing, engraving, printing, pad printing, laser or relief printing.

In some embodiments, the computer device is a computer, a mobile phone, a “Smartphone” type of device or a digital tablet.

In some embodiments, said patterns comprise at least one letter.

In some embodiments, said patterns comprise at least one digit.

In some embodiments, said patterns comprise at least one special character.

In some embodiments, said patterns comprise at least one full word, symbol, abbreviation, pictograph or drawing.

In some embodiments, said patterns are associated with at least one color.

According to a second aspect, the present invention envisages a sheet for the implementation of the method of the invention, bearing a plurality of patterns positioned in pattern positions, each pattern position corresponding to a symbol position on a predetermined physical interface, said sheet being flexible so that the pressing of a finger of a user on a pattern causes the input of a symbol, through the flexible sheet, on the physical symbol input interface, each pattern of a plurality of patterns on the flexible sheet representing a letter.

According to a third aspect, the present invention envisages a unit for generating and using at least one password, which comprises:
a flexible sheet of the plurality of flexible sheets that is the subject of the present invention; and
a first password imprinted on a mount, said first password being intended to be input on said flexible sheet to cause, by a mechanical effect, through said flexible sheet, the input of said second password, said second password being kept in the memory of a remote computer device.

According to a fourth aspect, the present invention envisages using a flexible sheet on a keyboard of a computer device, said flexible sheet comprising keys on which patterns are imprinted, and said keyboard also comprising keys on which symbols are imprinted, the keys of said flexible sheet being overlaid on the keys of said keyboard, at least one key of said flexible sheet having a pattern that is overlaid on a key of the keyboard having a symbol that is different from said pattern, said use being via input of a first password, having a meaning that is independent of its use as a password, on said flexible sheet to cause, by a mechanical effect, the input of a second password, not having any meaning that is independent of its use as a password, on said keyboard through said flexible sheet.

These embodiments apply in particular to the distribution in stores of flexible sheets utilized in the present invention, with operating instructions dedicated to their use that is the subject of the present invention.

The advantages, aims and characteristics of the subjects of the second, third and fourth aspects of the present invention being similar to those of the method that was the subject of the first aspect, they are not repeated here.

### BRIEF DESCRIPTION OF THE FIGURES

Other advantages, aims and characteristics of the present invention will become apparent from the description that will follow, made, as an example that is in no way limiting, with reference to the drawings included in an appendix, in which:

FIG. 1 illustrates the utilization of the method according to the present invention in one embodiment;

FIG. 2 represents a standard keyboard;

FIGS. 3 to 7 illustrate examples of flexible sheets comprising patterns, in accordance with the present invention;

FIG. 8 represents, in the form of a logical diagram, steps in a first particular embodiment of the method that is the subject of the present invention;

FIG. 9 represents, in the form of a logical diagram, steps in a second particular embodiment of the method that is the subject of the present invention;

FIG. 10 represents a plurality of flexible sheets that is the subject of the present invention;

FIG. 11 represents a unit for generating and using at least one password that is the subject of the present invention;

FIG. 12 represents, in the form of a logical diagram, steps of an initialization phase in a third particular embodiment of the method that is the subject of the present invention;

FIG. 13 represents, in the form of a logical diagram, steps of an operation phase of the third particular embodiment of the method that is the subject of the present invention;

FIG. 14 illustrates an example of a flexible sheet in accordance with the present invention; and

FIG. 15 illustrates a keyboard on which the flexible sheet illustrated in FIG. 14 may be positioned to declare and use a password.

### DETAILED DESCRIPTION OF EMBODIMENTS OF THE INVENTION

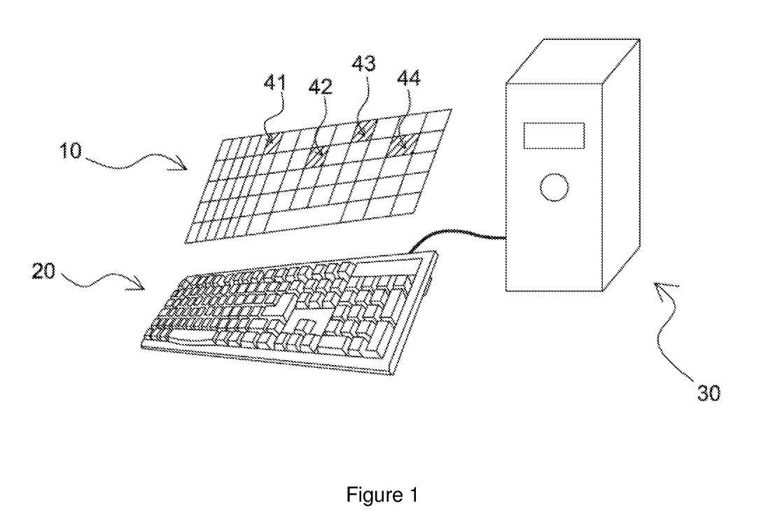

FIG. 1 illustrates the utilization of the method according to the present invention in one embodiment.

The method for generating and using passwords according to the present invention comprises the following steps:
affixing a flexible sheet 10 to a keyboard 20 of a computer device 30, said flexible sheet 10 comprising keys on which preferably random patterns 41, 42, 43, 44 are imprinted, and said keyboard 20 also comprising keys, the keys of said flexible sheet 10 being overlaid on the keys of said keyboard 20;
a user inputting a password on said keyboard 20 through said flexible sheet 10;
transmitting said password from said keyboard 20 to said computer device 30; and
processing of said password by means of said computer device 30 itself, or via a local area network (LAN) or a wide area network (WAN).

According to one embodiment, said flexible sheet 10 is made of one of the following materials: silicone elastomer, elastomer of a different composition, plastic, polymers, fabric or paper.

The flexible sheet 10 is molded or flat.

The random patterns 41, 42, 43, 44 are imprinted on the flexible sheet 10 by screen printing, engraving, printing, pad printing, laser, or relief printing, or by any other method of imprinting on said flexible sheet.

The random patterns 41, 42, 43, 44 can comprise at least one letter, at least one digit, at least one special character, at least one drawing, full word, symbol, pictograph or abbreviation, and at least one color.

The letters imprinted on said flexible sheet can be from any alphabet used in the world, in particular the following alphabets: Arabic, Armenian, Bengali, Bopomofo, braille, Coptic, Cyrillic, Devanagari, Greek, Georgian, Hangeul, Hebrew, Gojuon, Latin, Morse, Perso-arabic, Thai, Laotian, Vietnamese and Urdu.

The computer device 30 can be a desktop computer, a laptop computer, a mobile phone, a “Smartphone” type of device (touch screen or keyboard) or a touch or hybrid digital tablet (addition of a keyboard). If FIG. 1 represents a desktop computer, it is understood that the computer device 30 can also be a laptop computer, a mobile phone, a “Smartphone” type of device (touch screen or keyboard) or a touch or hybrid digital tablet (addition of a keyboard).

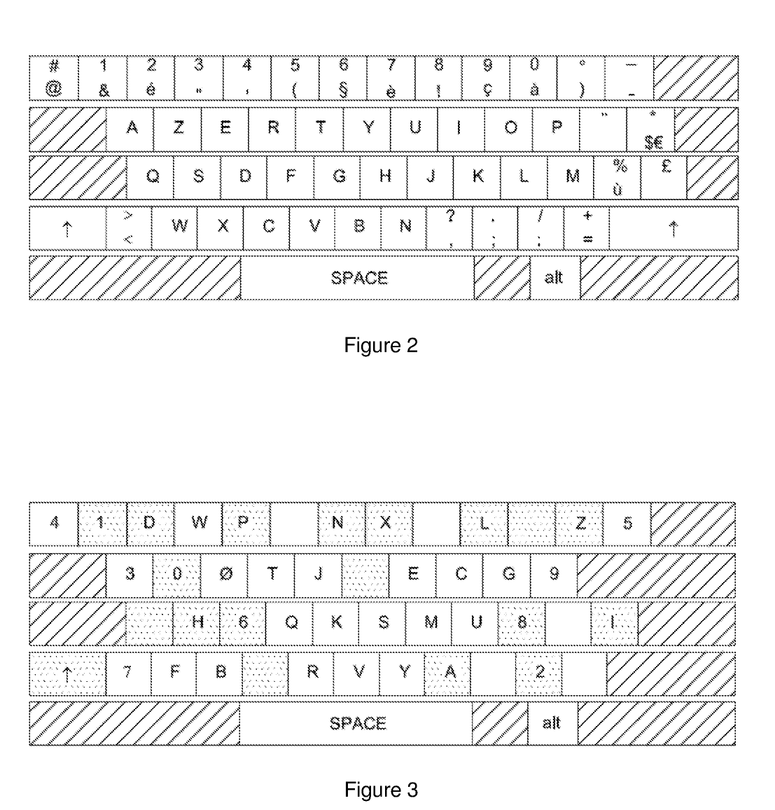

FIG. 2 represents one of the many standard keyboards that exist (the keys can differ according to the countries and brands). The computer keyboards all comply with the standards defined globally, with regard to keys, computer format, etc.

FIGS. 3, 4, 5, 6, and 7 illustrate flexible sheet examples 10 comprising patterns, in accordance with the present invention.

FIG. 3 shows such a flexible sheet 10 having random patterns 41, 42, 43, 44 in the form of digits, letters and words.

According to one embodiment, the user verifies his starting position. This must automatically be lower case. He then overlays the flexible sheet 10 on his keyboard 20, and inputs the password.

According to one embodiment, if the key is a color key, the user simultaneously presses the “Shift” key that is of the same color.

In this way, the user can input a simple code (for example Sylvie Thorel June 25 69), which is transformed into a more complex code (for example, with the flexible sheet shown in FIG. 3, “hn9b%urSZvu9/-tk%6Dp)”.

In this way, the transcription of the password in completely incomprehensible for a third party who would like to steal the password. The flexible sheet and the password generated and used are unique for each user, the patterns imprinted on each flexible sheet being random and the real password remaining in the individual's head.

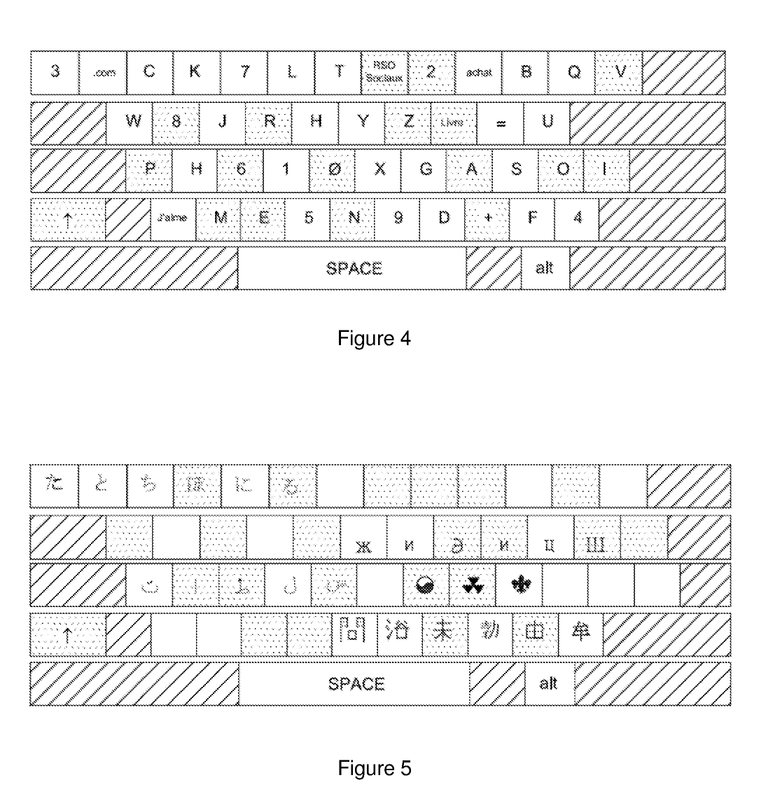

FIGS. 4 and 5 illustrate other flexible sheet examples 10 comprising patterns, in accordance with the present invention.

For example, FIG. 4 comprises a “Like” key and a “Book” key.

FIG. 5 also comprises non-Latin characters, in particular characters from Cyrillic, Arabic and Asiatic languages, ideograms and pictographs.

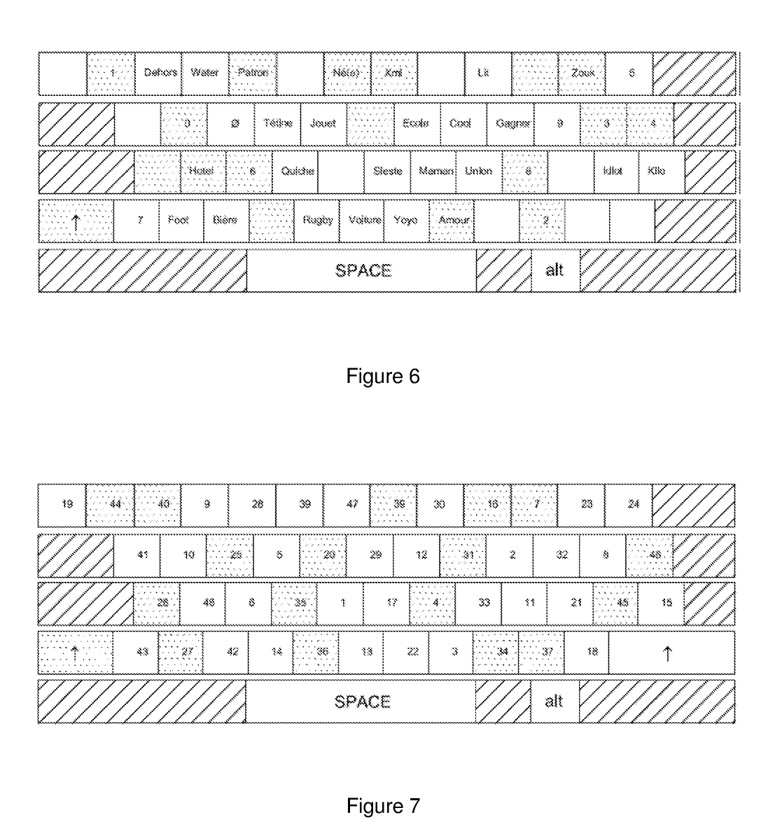

FIG. 6 comprises words.

FIG. 7 only comprises digits.

The flexible sheet 10 can also comprise company brand names, phrases.

The method according to the present invention offers many advantages, in particular with regard to memorization and simplicity of use.

The product can be used by all users of a computing device, computer (BIOS password, system, application, Internet) from any country, of all nationalities and of all ages. The product can be adaptable for all religions, eras, sports, themes, etc.

The product can be stored in a laptop computer in transport mode, or in a desk drawer. It is easily transportable, light and can be slipped into a pocket or handbag. In addition, it is difficult to tear and is water- and wear-resistant.

Over a billion combinations are generated by the method according to the present invention.

Lastly, the method according to the present invention is of great simplicity.

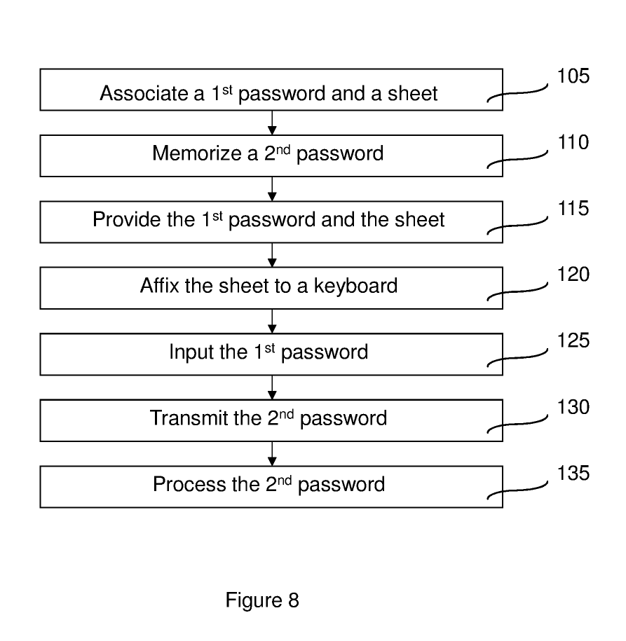

FIG. 8 shows a step 105 of associating a password (called the “first”) and a flexible sheet.

During a step 110, a second password, resulting from inputting the first password on the flexible sheet, is memorized.

Then a step 115 is carried out of simultaneously providing:
a first password; and
a flexible sheet, each flexible sheet being different for each user so that inputting the same first password on two flexible sheets causes two different second passwords to be input.

The flexible sheet comprises keys on which patterns are imprinted.

Preferably, the first password has a meaning for said user that is independent of the use thereof as a password.

Then a step 120 of affixing a flexible sheet to a keyboard of a computer device. The keyboard comprises keys on which symbols are imprinted. The keys of said flexible sheet are overlaid on the keys of the keyboard. During this step 120, at least one key of said flexible sheet has a pattern that is overlaid on a key of the keyboard having a symbol that is different from this pattern.

Then, the user carries out a step 125 of inputting the first password, consisting of said patterns. The input of each pattern of the first password by pressing the flexible sheet causes, through said flexible sheet, by a mechanical effect and by the deformation of the flexible sheet at the location of said pattern, the input on said keyboard of a symbol of a second password which is different from the first password.

Preferably, the second password has no meaning independent of the use thereof as password.

During a step 130, the keyboard transmits the second password to a computer device.

During a step 135, the computer device itself, a local area network (LAN) or a wide area network (WAN) processes the second password to validate, or not, access to a local or remote resource.

As can be seen by reading the description above, transcribing the first password, which is understandable and therefore can be memorized by the user, into a second password, which is incomprehensible both to the user and to a third party who would like to discover it, strengthens the level of security without requiring any effort on the part of the user. Because no specific software system is required on the user terminal, no malware program such as a keylogger or Trojan horse and no remote control of this terminal can reveal the first password.

It is noted that, by regularly changing the flexible sheet, the present invention allows the second password to be regularly changed, as is recommended for computer security, while continuing to use the same first password. Similarly, with several flexible sheets it is possible to use different second passwords to access different resources, while using the same first password.

In this way, a user can have a password “for life”, which is used as a first password, for example formed from his last name, at least one first name and a date of birth, appended without spaces, e.g. “SylvieThorelJune251969”, which provides an easily remembered 22-character code, currently sufficient with regard to the computing power of the of the computer systems available to malicious third parties, even well-equipped secret services.

To further increase the security of the second password, actually used to access a resource, the distribution of patterns on the flexible sheet and each of the passwords are preferably unique for each user, and the patterns imprinted on each flexible sheet are preferably random.

This embodiment applies, in particular, to the case in which a website operator supplies a password to a user of this site. During the step 115, for example, a bank supplies, for accessing the account of each of its customers:
a letter or flexible card bearing the first password (for example “mybankcode”); and
a unique flexible sheet (different for each customer).

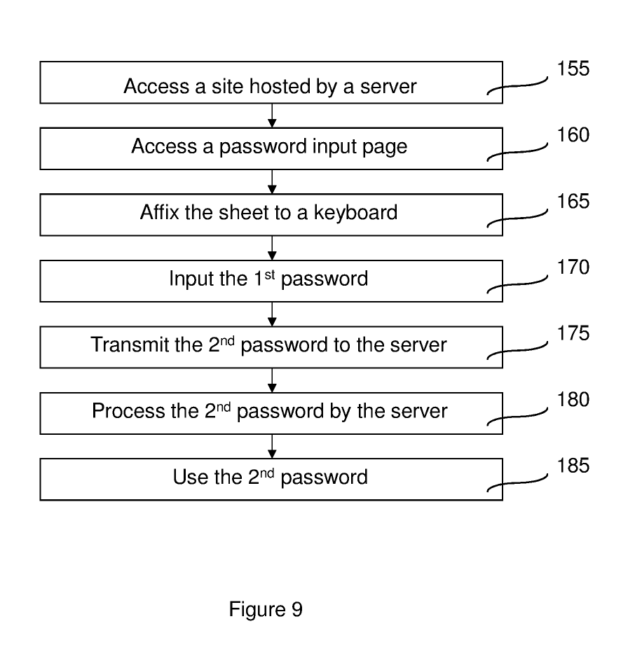

FIG. 9 shows a step 155 of a user accessing a website, with a computer device or user terminal, then a step 160 of accessing a page in this site in order to memorize a password for access to personal data. Depending on the case, the user memorizes such a password for the first time on this site, or modifies his password for this site.

Once access to the entry field for the future password (called “second”) has been obtained, the user carries out a step 165 of affixing a flexible sheet to a keyboard of a computer device, as described above.

Then, the user carries out a step 170 of inputting the first password, consisting of said patterns. The input of each pattern of the first password by pressing the flexible sheet causes, through said flexible sheet, by a mechanical effect and by the deformation of the flexible sheet at the location of said pattern, the input on said keyboard of a symbol of a second password which is different from the first password. Preferably, the second password has no meaning independent of the use thereof as password.

During a step 175, the keyboard transmits the second password to a computer device, and the computer device to the server hosting the website.

During a step 180, the server processes the second password to memorize it. Subsequently, during a step 185, this second password is used as described with reference to steps 120 to 135.

As can be seen by reading the description above, transcribing the first password, which is understandable and therefore can be memorized by the user, into a second password, which is incomprehensible both to the user and to a third party who would like to discover it, strengthens the level of security without requiring any effort on the part of the user. Because no specific software system is required on the user terminal, no malware program such as a keylogger or Trojan horse and no remote control of this terminal can reveal the first password.

It is noted that, by regularly changing the flexible sheet, the present invention allows the second password to be regularly changed, as is recommended for computer security, while continuing to use the same first password. Similarly, with several flexible sheets it is possible to use different second passwords to access different resources, while using the same first password.

In this way, a user can have a password “for life”, which is used as a first password, for example formed from his last name, at least one first name and a date of birth, appended without spaces, e.g. “SylvieThorelJune251969”, which provides an easily remembered 22-character code, currently sufficient with regard to the computing power of the of the computer systems available to malicious third parties, even well-equipped secret services.

To further increase the security of the second password, actually used to access a resource, the distribution of patterns on the flexible sheet and each of the passwords are preferably unique for each user, and the patterns imprinted on each flexible sheet are preferably random.

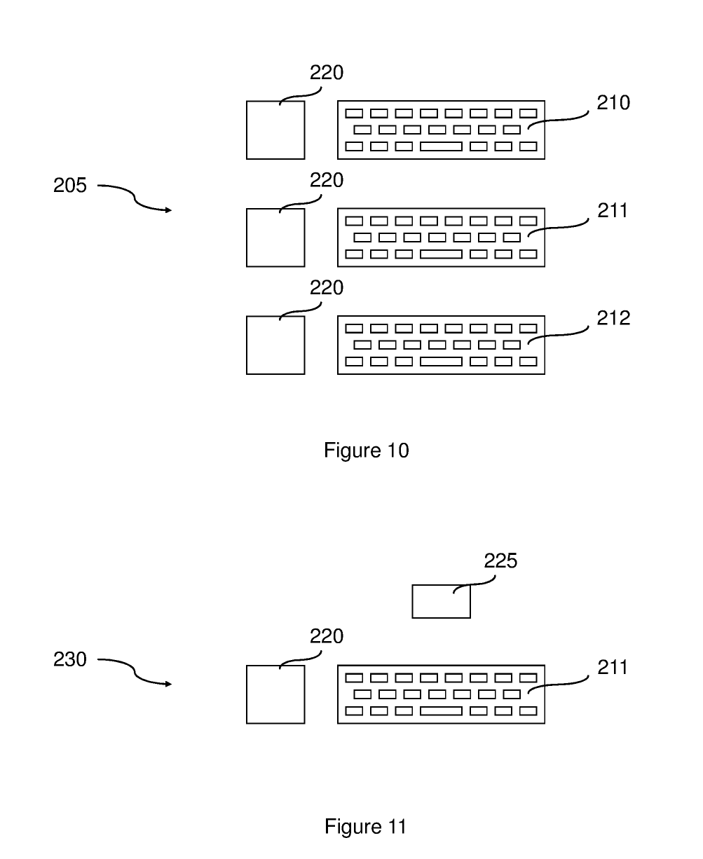

FIG. 10 shows a plurality 205 of flexible sheets 210 to 212, each flexible sheet of the plurality of flexible sheets comprises keys on which patterns are imprinted, the set of patterns imprinted on each flexible sheet being different from the set of patterns imprinted on any other flexible sheet in said plurality of flexible sheets.

Preferably, each flexible sheet 210 to 212 is associated with operating instructions 220 describing all or part of steps 155 to 185 of FIG. 9.

These embodiments apply in particular to the distribution in stores of flexible sheets utilized in the present invention, with operating instructions dedicated to their use that is the subject of the present invention.

FIG. 11 shows a unit 230 for generating and using at least one password, which comprises:
a flexible sheet 211 of the plurality 205 of flexible sheets illustrated in FIG. 10; and
a first password imprinted on a mount 225, said first password being intended to be input on said flexible sheet to cause, by a mechanical effect, through said flexible sheet, the input of said second password, said second password being kept in the memory of a remote computer device.

Preferably, the flexible sheet 211 is associated with operating instructions 220 describing all or part of steps 105 to 135 of FIG. 8.

In some embodiments, some characters are duplicated on the flexible sheet but with different visual characteristics, e.g. in two different colors, one set of characters in upright characters and one set of italics. For example, only the vowels are duplicated on the flexible sheet. To use the first password and the same flexible sheet, while modifying the second password the user changes, regularly or for different utilizations, the colors of some duplicated characters. In this way he increases the security of access to his personal data. According to another example, the characters used most frequently, e.g. “a” and “e” on a French keyboard, are in more than two colors (or other visual characteristics than color) on the same sheet such that, by remembering the color associated with each site, the user supplies different second passwords on different sites (or successively for the same site) while keeping the same first password in memory.

In some embodiments, the flexible sheet is designed to correspond to several positions on the same keyboard, for example by translation. For example, the flexible sheet covers four lines of seven keys of the keyboard to represent 28 patterns representing, for example, the 26 letters of the alphabet. Thus, the same sheet can be placed in at least two different positions on the same keyboard and so, by inputting the same first password on this flexible sheet, input different second passwords. By memorizing, for each confidential resource that the user wishes to access, the flexible sheet's specific position amongst the various positions, the same first password allows different second passwords to be generated.

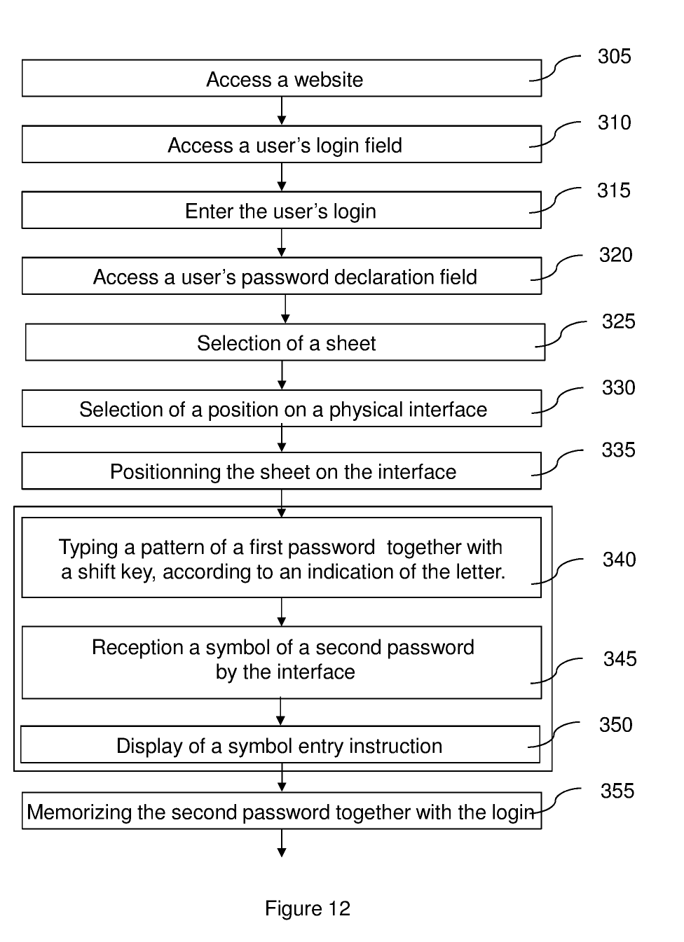

FIG. 12 represents, in the form of a logical diagram, steps of an initialization phase in a third particular embodiment of the method that is the subject of the present invention.

In step 305, a user gains access to a website. In step 310, the user gains access to a page for creating or editing a user's account or requiring a right to access a resource. The resources that may be only accessible after user's identification may incorporate accessing personal data, accessible a database, accessing personal bank account, accessing personalized services.

The page for creating or editing a user's account generally includes a field for entering a login, for example a name, an identifier provided by the website, an email address, a phone number and a filed for entering a password. Sometimes, at least one of the field is duplicated on the page so as to make sure the user did not make mistake while entering data.

The user than clicks on the field for entering the login.

In step 315, the user types a user's login.

In step 320, the user clicks on the field for declaring a password.

In step 325, the user selects a flexible sheet. In case the user only has one flexible sheet according to the invention, the user does not select a sheet.

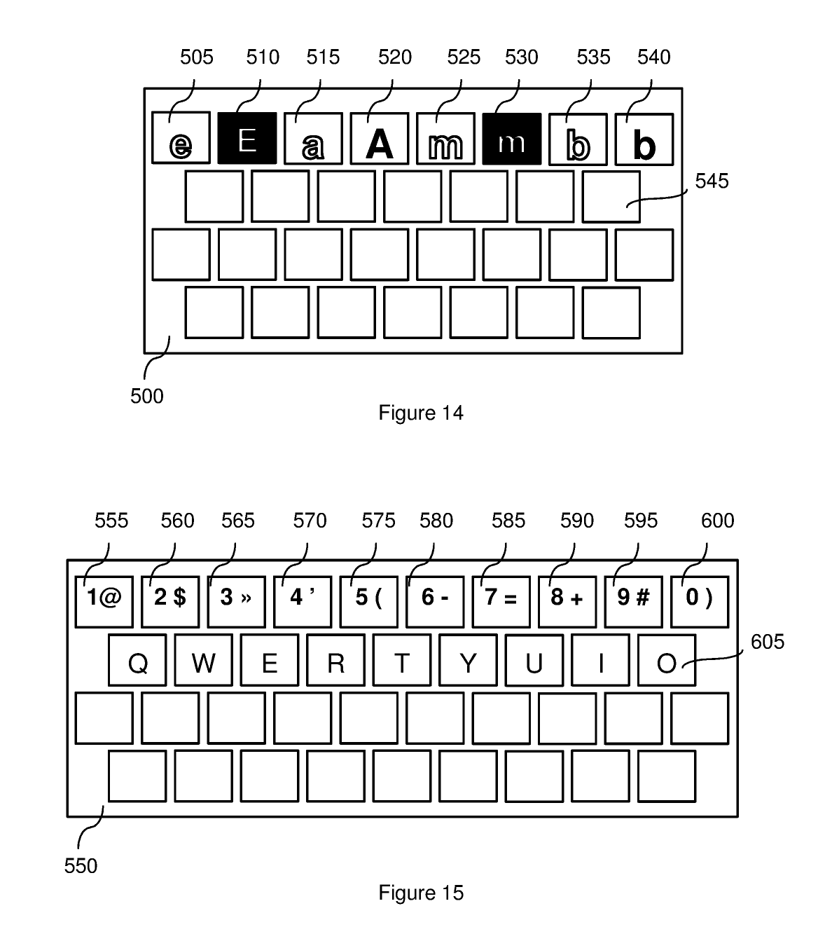

In step 330, the user selects a position on a physical interface where a flexible sheet may be positioned. The physical interface may be a keyboard or a touchscreen displaying keys. Each key of the physical interface bears a symbol (e.g., alpha. As shown in FIGS. 14 and 15, some embodiments of sheets according to the invention may be positioned at different positions on a physical interface (i.e., the “e” pattern 505 of the flexible sheet 500 shown in FIG. 14 may be positioned either on keys 555 “1169 ”, 560 “2$” or 565“3″” while the other patterns of the sheet are each superimposed on a different key of the keyboard 550 shown in FIG. 15).

In step 335, the user positions the selected sheet at the selected position on the physical interface. Note that the computer or terminal settings, particularly the language of the keyboard is not changed. Thus, there is no correspondence between the flexible sheet patterns and the setting of the computer.

Steps 340 to 350 are repeated for each one of the symbols forming the first human readable and memorizable password that will be memorized by the user and the second not human memorizable password that will be stored and used by the website.

In step 340, the user types a pattern of the first password on the flexible sheet. In embodiments of the flexible sheet that have different categories of patterns for instructing the user to simultaneously press the “shift” key and said pattern, the user either presses the pattern alone or presses the pattern together with the “shift key”.

Different categories of patterns may be, for example:
patterns written in different colors,
patterns written on different backgrounds,
upper cases and lower cases.

In step 345, a symbol that is under the pattern that is typed is entered by the physical interface.

In step 350, a mark is shown in the password field for confirming that a symbol of the password has been entered by the physical interface. Said mark may be the symbol itself or a fixed symbol (e.g., “*” or “-”).

In step 355, the website server memorizes the second password together with the login given by the user during step 310.

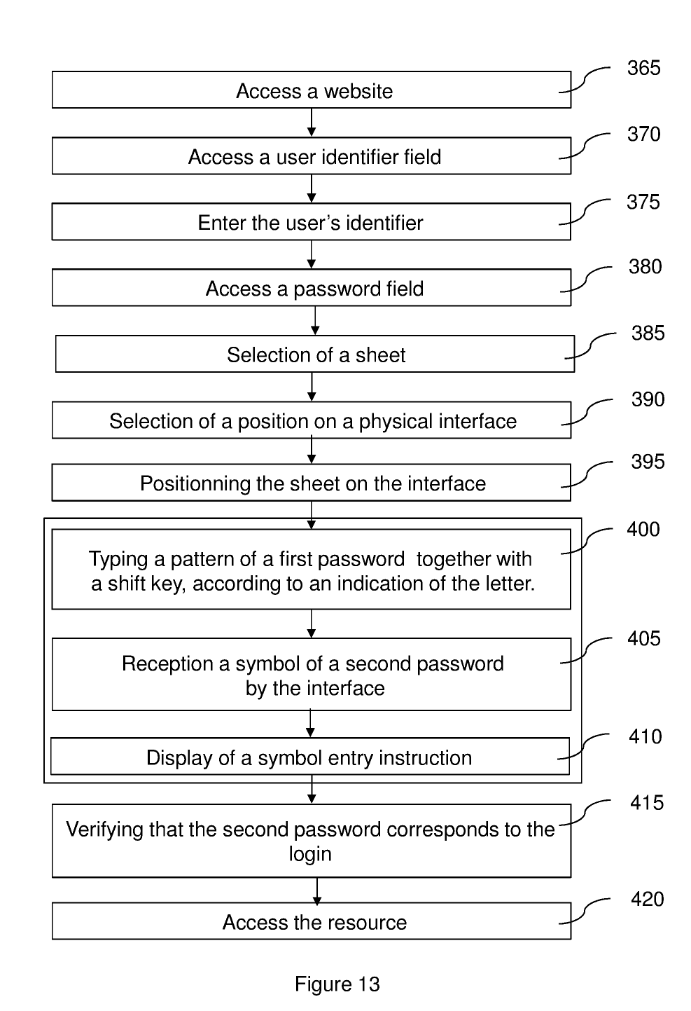

FIG. 13 represents, in the form of a logical diagram, steps of an operation phase of the third particular embodiment of the method that is the subject of the present invention.

In step 365, a user gains access to a website. In step 370, the user gains access to a page for accessing restricted resources of the website. The page for accessing restricted resources generally comprises accessing a user's account, by entering the login and the second password. The user than clicks on the field for entering the login.

In step 375, the user types the user's login.

In step 380, the user clicks on the field for entering the second password.

In step 385, the user selects the flexible sheet used for declaring the password (step 325). In case the user only has one flexible sheet according to the invention, the user does not select a sheet.

In step 390, the user selects the same position as in step 330.

In step 395, the user positions the selected sheet at the selected position on the physical interface.

Steps 400 to 410, respectively similar to steps 340 to 350 are repeated for each one of the symbols forming the second password as memorized by the website's server.

In step 415, the website server check if the password entered in steps 400 to 410 is identical to the second password stored in this server. If yes, in step 420, the user accesses the protected resource.

With regard to FIGS. 12 and 13, the method of the invention to access a resource with a password hard to memorize for a user, comprises:

during a initialization phase shown in FIG. 12:

a first step of supplying, by the user, in an identifier input field displayed on a screen of a terminal, an identifier of the user,
a first step of accessing a user password declaration field, by the user;
a first step of affixing, on a physical symbol input interface comprising a plurality of symbols positioned in symbol positions, a flexible sheet bearing a plurality of patterns positioned in pattern positions, each pattern position being superposed on a symbol position, the pressing of a finger of the user on a pattern causing the input of a symbol, through the flexible sheet, on the physical symbol input interface, each pattern of a plurality of patterns on the flexible sheet representing a letter;
a first step of input, by the user, by pressing on patterns of the flexible sheet, of a first arbitrary password comprising a plurality of patterns representative of letters, causing the reception by the physical interface, through the flexible sheet, of a sequence of symbols constituting a second password, each reception of a symbol by the physical interface causing the display, in the declaration field, of a sign confirming the reception and
a step of memorization, by a computer system, of the pair of information constituted of the sequence of symbols constituting the second password and of the user identifier as a pair of information authorizing the access to the resource; and

during a utilization phase shown in FIG. 13:
a second step of supplying, by the user, in the identifier input field displayed on a screen of a terminal, the identifier of the user,
a second step of accessing a user password declaration field, by the user;
a second step of affixing, on a physical symbol input interface, the flexible sheet each pattern position being superposed on a symbol position;
a second step of input, by the user, by pressing on patterns of the flexible sheet, of the first password causing the reception by the physical interface, through the flexible sheet, of the sequence of symbols constituting the second password, each reception of a symbol by the physical interface causing the display, in the declaration field, of a sign confirming the reception and
a step of verification of correspondence, in a memory, of the pair of information constituted of the sequence of symbols constituting the second password and of the user identifier;
if the second password corresponds to the user identifier, a step of accessing the resource.

As explained, in embodiments, the method further comprises, during each input step, the affixing of a sheet comprising patterns of at least two different colors and/or different backgrounds and a step of pressing, by the user, on a shift key of the physical interface, simultaneously to pressing a pattern on the sheet, when the pattern or the background is in a predetermined color.

In embodiments, the method comprises, during each input step, the affixing of a sheet comprising patterns representing upper case and lower case letters, and a step of pressing, by the user, on a shift key of the physical interface, simultaneously to pressing a pattern on the sheet representing an upper case letter.

In embodiments, during each input step by the user, at least one pattern representing a letter is superposed on at least one symbol representing a special character.

In embodiments, the method further comprises, during each step of affixing the flexible sheet on the physical interface, a selection of the positioning of the sheet, a plurality of positions of the sheet superposing the position of each pattern of the sheet on a position of a symbol on the physical interface.

In embodiments, the method further comprises, during each step of affixing the flexible sheet on the physical interface, a selection of a sheet from a plurality of sheets, at least one pattern being positioned differently on two different sheets.

In embodiments, the method further comprises, during each step of affixing the flexible sheet on the physical interface, the use of a sheet comprising, for at least one letter, at least two patterns in two different pattern positions representing said letter. In embodiments, at least two patterns representing the same letter possess different colors and/or different backgrounds. In embodiments, at least two patterns representing the same letter represent said letter in upper case for one of said patterns and in lower case for another of said patterns.

In embodiments, each input field is displayed on a webpage.

FIG. 14 illustrates an example of a flexible sheet 500 comprising patterns 505 to 545. Only the patterns of the first line are shown in FIG. 14. In this flexible sheet 500, are printed:
patterns representing letters that are to be typed as lower case letters, by not pressing the shift key, 505, 515, 525 and 535, and
patterns representing letters that are to be typed as upper-case or capital letters, by pressing the shift key, 510, 520, 530 and 540.

The difference between two letters, one to be typed as lower-case letter and the other one to be typed as upper-case letter may be visible as:
the background may be different, as for patterns 505 and 510 or 525 and 530,
the letters may be either in upper-case or lower-case, as for patterns 505 and 510, 515 and 520,
the letters may be either in bold or not, as for patterns 505 and 510, 515 and 520, 525 and 530 or 535 and 540,
the color of the letter may be different, as for patterns 505 and 510 or 525 and 530.

Preferably, the differences between the letters that are to be typed while pressing the shift key (upper-case) and the other letters (lower-case) are consistent on the whole flexible sheet. FIG. 14 shows a mix of those differences for explanation purpose only.

In embodiments, letters are written twice or more on the flexible sheet, but with differences as explained in view of FIG. 14, no upper-case is used but the user chooses a set of similar letters with which the user enters the first password. For example:
the user will only type on patterns or letters having the same color, not using the patterns or letters having another color,
the user will only type on patterns or letters having the same background, not using the patterns or letters having another background,
the user will only type on letters being either in upper-case or in lower-case, not using the other letters,
the user will only type on patterns or letters in bold or not, not using the other patterns or letters.

Obviously, for each password used by the user, a different rule can be applied by the user. In those embodiments, the flexible sheet may look like flexible sheet 500 shown in FIG. 14, with many differences between patterns (both background difference, color difference, italic difference, bold difference, and/ or upper/lower case difference).

FIG. 15 illustrates a keyboard 550 on which the flexible sheet illustrated in FIG. 14 may be positioned to declare and use a password. Physical symbols are printed on keys 555 to 605 of this keyboard. Only the physical symbols of the first two lines are shown in FIG. 15.

The invention is described above by way of example. It is understood that the person skilled in the art is able to realize different embodiments without in any way leaving the framework of the patent.

As explained above, the sheet for the implementation of the method of the invention, bears a plurality of patterns positioned in pattern positions, each pattern position corresponding to a symbol position on a predetermined physical interface, said sheet being flexible so that the pressing of a finger of a user on a pattern causes the input of a symbol, through the flexible sheet, on the physical symbol input interface, each pattern of a plurality of patterns on the flexible sheet representing a letter.

In embodiments, the sheet further comprises patterns of at least two different colors and/or different backgrounds, a predetermined color or background representing an instruction for the user to press on a shift key of the physical interface simultaneously to pressing a pattern on the sheet, presenting said color or background.

In embodiments, the sheet bears a written instruction, for said predetermined color and/or background, to simultaneously press the shift key when the user presses on a patter presenting said color and/or said background.

In embodiments, the sheet further comprising patterns representing upper case and lower-case letters, an upper-case letter being representative of an instruction for a user to press on a shift key simultaneously to pressing a pattern on the sheet representing an upper-case letter.

In embodiments, the sheet bears a written instruction to press simultaneously on a shift key when the user presses on a pattern representing an upper-case letter.

In embodiments, the sheet is configured so that at least one patter representing a letter is superposed on a symbol on the physical interface representing a special character.

In embodiments, the sheet is configured so as to be positioned in a plurality of different positions on the physical interface, each position of the plurality of positions of the sheet on the physical interface superposing the position of each pattern of the sheet to a position of a symbol on the physical interface.

In embodiments, the sheet further comprises, for at least one letter, at least two patterns in two different pattern positions representing said letter.

In embodiments, at least two patterns representing the same letter possess different colors and/or different backgrounds.

In embodiments, at least two patterns representing the same letter represent said letter in upper case for one of said patterns and in lower case for another of said patterns.

1. Method to access a resource with a password hard to memorize for a user, comprising:
during a initialization phase:
a first step of supplying, by the user, in an identifier input field displayed on a screen of a terminal, an identifier of the user,
a first step of accessing a user password declaration field, by the user;
a first step of affixing, on a physical symbol input interface comprising a plurality of symbols positioned in symbol positions, a flexible sheet bearing a plurality of patterns positioned in pattern positions, each pattern position being superposed on a symbol position, the pressing of a finger of the user on a pattern causing the input of a symbol, through the flexible sheet, on the physical symbol input interface, each pattern of a plurality of patterns on the flexible sheet representing a letter;
a first step of input, by the user, by pressing on patterns of the flexible sheet, of a first arbitrary password comprising a plurality of patterns representative of letters, causing the reception by the physical interface, through the flexible sheet, of a sequence of symbols constituting a second password, each reception of a symbol by the physical interface causing the display, in the declaration field, of a sign confirming the reception and
a step of memorization, by a computer system, of the pair of information constituted of the sequence of symbols constituting the second password and of the user identifier as a pair of information authorizing the access to the resource and
during a utilization phase:
a second step of supplying, by the user, in the identifier input field displayed on a screen of a terminal, the identifier of the user,
a second step of accessing a user password declaration field, by the user;
a second step of affixing, on a physical symbol input interface, the flexible sheet each pattern position being superposed on a symbol position;
a second step of input, by the user, by pressing on patterns of the flexible sheet, of the first password causing the reception by the physical interface, through the flexible sheet, of the sequence of symbols constituting the second password, each reception of a symbol by the physical interface causing the display, in the declaration field, of a sign confirming the reception and
a step of verification of correspondence, in a memory, of the pair of information constituted of the sequence of symbols constituting the second password and of the user identifier;
if the second password corresponds to the user identifier, a step of accessing the resource.

2. Method according to claim 1, comprising, during each input step, the affixing of a sheet comprising patterns of at least two different colors and/or different backgrounds and a step of pressing, by the user, on a shift key of the physical interface, simultaneously to pressing a pattern on the sheet, when the pattern or the background is in a predetermined color.

3. Method according to claim 1, comprising, during each input step, the affixing of a sheet comprising patterns representing upper case and lower case letters, and a step of pressing, by the user, on a shift key of the physical interface, simultaneously to pressing a pattern on the sheet representing an upper case letter.

4. Method according to claim 1, wherein, during each input step by the user, at least one pattern representing a letter is superposed on at least one symbol representing a special character.

5. Method according to claim 1, comprising, during each step of affixing the flexible sheet on the physical interface, a selection of the positioning of the sheet, a plurality of positions of the sheet superposing the position of each pattern of the sheet on a position of a symbol on the physical interface.

6. Method according to claim 1, comprising, during each step of affixing the flexible sheet on the physical interface, a selection of a sheet from a plurality of sheets, at least one pattern being positioned differently on two different sheets.

7. Method according to claim 1, comprising, during each step of affixing the flexible sheet on the physical interface, the use of a sheet comprising, for at least one letter, at least two patterns in two different pattern positions representing said letter.

8. Method according to claim 7, wherein at least two patterns representing the same letter possess different colors and/or different backgrounds.

9. Method according to claim 7, wherein at least two patterns representing the same letter represent said letter in upper case for one of said patterns and in lower case for another of said patterns.

10. Method according to claim 1, wherein each input field is displayed on a webpage.

11. Sheet for the implementation of the method according to claim 1, bearing a plurality of patterns positioned in pattern positions, each pattern position corresponding to a symbol position on a predetermined physical interface, said sheet being flexible so that the pressing of a finger of a user on a pattern causes the input of a symbol, through the flexible sheet, on the physical symbol input interface, each pattern of a plurality of patterns on the flexible sheet representing a letter.

12. Sheet according to claim 11, comprising patterns of at least two different colors and/or different backgrounds, a predetermined color or background representing an instruction for the user to press on a shift key of the physical interface simultaneously to pressing a pattern on the sheet, presenting said color or background.

13. Sheet according to claim 12, bearing a written instruction, for said predetermined color and/or background, to simultaneously press the shift key when the user presses on a patter presenting said color and/or said background.

14. Sheet according to claim 11, comprising patterns representing upper case and lower-case letters, an upper-case letter being representative of an instruction for a user to press on a shift key simultaneously to pressing a pattern on the sheet representing an upper-case letter.

15. Sheet according to claim 14, bearing a written instruction to press simultaneously on a shift key when the user presses on a pattern representing an upper-case letter.

16. Sheet according to claim 11, configured so that at least one patter representing a letter is superposed on a symbol on the physical interface representing a special character.

17. Sheet according to claim 11, configured so as to be positioned in a plurality of different positions on the physical interface, each position of the plurality of positions of the sheet on the physical interface superposing the position of each pattern of the sheet to a position of a symbol on the physical interface.

18. Sheet according to claim 11, comprising, for at least one letter, at least two patterns in two different pattern positions representing said letter.

19. Sheet according to claim 18, on which at least two patterns representing the same letter possess different colors and/or different backgrounds.

20. Sheet according to claim 18, on which at least two patterns representing the same letter represent said letter in upper case for one of said patterns and in lower case for another of said patterns.
